(19) United States
(12) Patent Application Publication
(10) Pub. No.: US 2003/0004671 A1
(43) Pub. Date: Jan. 2, 2003

(54) Remote debugging apparatus for executing procedure preregistered in database at program breakpoint

(75) Inventor: Isao Minematsu, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/155,070

(22) Filed: May 28, 2002

(30) Foreign Application Priority Data
Jun. 28, 2001 (JP) 2001-196796 (P)

(51) Int. Cl. G01M 19/00

(52) U.S. Cl. 702/123

(57) ABSTRACT

A remote debugging apparatus that uses a development terminal coupled to an evaluation board with a plurality of processing modules including a processor in a master-slave configuration, includes: a setting module for pre-setting a breakpoint in a program executed in the evaluation board; and a registering module for registering a procedure in a database provided either on the evaluation board or on the development terminal. The procedure is performed for a memory on the evaluation board when the breakpoint is hit. The apparatus further includes; an execution-commencing module for starting the program in the evaluation board; and an execution-controlling module for referencing the database in response to a hit on the breakpoint, and controlling the processing module of the evaluation board to execute a procedure required to be done on the memory of the evaluation board.

### BACKGROUND OF THE INVENTION

1. Field of the Invention

The present invention relates to a software-debugging apparatus that operate in a system configured of a main processor and another processor (such as a coprocessor or a direct memory access controller (DMAC) processor) that can operate in parallel with the main processor. More particularly, the present invention relates to a so-called remote debugging apparatus for debugging software for embedded applications in a master-slave system by using a development terminal.

2. Description of the Background Art

Conventionally, a typical board (a system) for embedded applications includes a single processor, a memory including a RAM (random access memory) and a ROM (read-only memory), and a logic unit. However, with recent diversities in arithmetic operations and advances in the integration density, so-called multiprocessor configurations are increasingly used. In the multiprocessor configuration, multiple processors are integrated on a board (or, within one chip to be mounted on a board).

From the viewpoint of the way of combining processors, multiprocessor architecture is divided into two types. The first type is a parallel type that uses a plurality of identical processors equally related to each other. The second type is a so-called master-slave type in which a master or slave function is explicitly assigned to the individual processors.

The multiprocessor architecture is also divided into two types in view of the way of connecting processors. The first type is a closely coupled type in which the processors are coupled to each other by using dedicated signal-line interfaces. The second type is a loosely coupled type in which the processors are coupled by using buses or switches.

Multiprocessor configurations include many types of configurations of intermediate types, in addition to the above-described typical types. Further, the configurations include those built by combining the aforementioned types.

In the multiprocessor system, programs are executed in multiple processors to thereby implement the overall system function. The aforementioned characteristics make program debugging to be problematic. To solve the problem, improvement needs to be made for, for example, the debug functions, the debugger, and processor-processor interfaces. An example is a processor-processor interface proposed in Japanese Patent Laying-Open No. 10-187486/1998. The processor-processor interface is used in a multiprocessor system of a parallel, and a loosely coupled type.

In most cases, software for embedded applications on board with a mounted processor is debugged using a development terminal, such as an engineering workstation (EWS). This type of debugging is called “remote debugging”, and a debugging program is called a “remote debugger”.

The remote debugger includes two module sections: one is a front-end section, and the other is a resident monitor section. The front-end section serves as a human-machine interface, activated by the development terminal that is operated by a user (such as a programmer) and the resident monitor section resides on the board. These modules mutually exchange, for example, commands and command-execution results, by using the development terminal and communication functions (such as RS232C, Ethernet(R), and JTAG (Joint Test Action Group)).

Primary functions of the debugger include a debugging function using breakpoints. In the breakpoint debugging function, program execution terminates when control of the program execution has reached an instruction at a specified address. The memory address of such an instruction address is called a “breakpoint”. Generally, when a breakpoint is set, the debugger replaces a specified address in a debug-target program with a specific instruction. During the program execution, when an execution instruction address has reached the specified breakpoint, control branches to a software interrupt handler corresponding to the specific instruction. The interrupt handler saves context of the debug-target program, then passes control to the resident monitor section. Upon receipt of control, the resident monitor section notifies the front-end section that the instruction-execution address has reached the specified breakpoint. Subsequently, control is passed to the front-end section. Thereby, a user can perform debugging.

For the user to continue the program execution by using a user command, the resident monitor section restores the context of the debug-target program. Then, a return instruction from the software interrupt dispatches execution of the debug-target program to be continued to the resident monitor section.

In the remote debugging method, to debug a memory-mapped input/output device on a board, even when a user uses a memory-referencing function provided to reference the status of the input/output device after detection of a breakpoint, latency occurs momentary after the breakpoint is reached (hit). This raises problems in that the status when the breakpoint is reached cannot be accurately known, and debugging encounters difficulties.

These problems are caused not only in software debugging using an ordinary input/output device such as a DMA controller (DMA: direct memory access), but also in a multiprocessor system of the loosely coupled type. In particular, in a multiprocessor system of the master-slave type, even if a program running in the master processor has reached a breakpoint, a program running in the slave processor does not stop immediately. This raises another problem that makes it difficult to debug the overall system.

### SUMMARY OF THE INVENTION

The present invention is made to solve the above-described problems, and one of its objects is to provide a remote debugging apparatus that enable the status on an evaluation board at the time of breakpoint hit to be reflected on debugging at higher accuracy in a master-slave type multiprocessor system.

Another object of the present invention is to provide a remote debugging apparatus that enable the status on an evaluation board at the time of breakpoint hit to be obtained at a higher speed and to be reflected on debugging.

According to one aspect of the present invention, a remote debugging apparatus, implemented by a computer, for debugging a program executed on an evaluation board including a plurality of processing modules in a master-slave configuration by using a development terminal coupled to the evaluation board includes: a module for pre-setting a breakpoint in the program executed on the evaluation board; a module for registering a procedure to be conducted when a breakpoint is hit in a database; a module for initiating the execution of the program on the evaluation board; and a module for dispatching execution of a procedure on a processing module on the evaluation board to be done upon a memory on the evaluation board by referencing the database in response to a hit on the breakpoint.

The procedure required when the breakpoint is hit is pre-registered in the database. When the breakpoint is hit, the procedure is read out of the database, and is executed. Compared to a case where a user specifies the procedure when a specified breakpoint is hit, the delay can be reduced in executing debugging operation after a breakpoint is hit. Consequently, the status of the breakpoint-hit-time evaluation board can be accurately reflected on the debugging. Furthermore, the debugging can be facilitated.

Preferably, the database is provided on the evaluation board.

With the database provided on the evaluation board, communication need not be performed in the development terminal when the breakpoint is hit. This reduces the overhead for communication, and reduces the delay in executing debugging procedure after a breakpoint-hit. Consequently, the status of the evaluation board at the time of a breakpoint-hit can be reflected more accurately on the debug procedure. Furthermore, the debugging can be facilitated.

Alternatively, the database may be provided in the development terminal.

With the database provided in the development terminal, different from the case where the database is provided on the evaluation board, only a function of performing communication with the development terminal needs to be implemented on the evaluation board when the breakpoint is hit. In this case, a debug-dedicated remote resident section of the evaluation board can be minimized. This makes it easy to design the evaluation board.

The module for registering preferably includes a module for preliminarily registering an address in the memory of the evaluation board into the database provided either on the evaluation board or on the development terminal. The address to be registered into the database is required to be accessed when the breakpoint is hit. The module for dispatching may include a module for referencing the database in response to a hit on the breakpoint in execution of the program, reading out data in the memory of the evaluation board at an address read out of the database, and controlling the processing module to notify the read-out data to the development terminal; and a module for outputting to an outputting module the data notified to the development terminal.

When the breakpoint is hit, the data can be read out of the evaluation-board memory at the address pre-registered in the database, and the data can be displayed. The time required to read out the data after the breakpoint is hit can be reduced. This enables the status of the evaluation board at the time of a breakpoint-hit to be known even more accurately. Consequently, the debugging of software executed in the evaluation board is facilitated.

Preferably, the module for registering includes a module for pre-registering in the database an address in the memory of the evaluation board and data required to be written at the address. The address is required to be accessed when the breakpoint is hit, and the database is provided either on the evaluation board or on the development terminal. Furthermore, the module for dispatching may include a module for referencing the database in response to a hit on the breakpoint in execution of the program, and controlling the processing module of the evaluation board to write data read out of the database in the memory of the evaluation board at an address read out of the database.

When the breakpoint is hit, data pre-registered in the database can be written in the memory of the evaluation board at the address pre-registered in the database. Thereby, the time required to write the data after the breakpoint is hit can be reduced. This enables the status of the evaluation board at the time of a breakpoint-hit to be reflected on the debug even more accurately. Consequently, the debugging of the evaluation board is facilitated.

The module for registering preferably includes a module for generating an instruction sequence dependent from the processing module required to be executed by the processor of the evaluation board according to a command from a user at the development terminal when the breakpoint is hit to be registered in the database that is provided on the evaluation board. The module for dispatching may include a module for referencing the database in response to a hit on the breakpoint in execution of the program, and providing the processing module with the instruction sequence read out of the database to be executed.

In the preferable case, a procedure to be executed when the breakpoint is hit is converted into the instruction sequence, and the converted instruction sequence is registered. When the breakpoint is hit, the processing module of the evaluation board is controlled to directly execute the instruction sequence. Thereby, high-rate execution can be achieved for the procedure to be performed for the debug procedure when the breakpoint is hit. Hence, reduction can be achieved for the delay in executing debugging after the breakpoint is hit. That is, the time required to read out the data after the breakpoint is hit can be reduced. This enables the status of the evaluation board at the time of a breakpoint-hit to be known even more accurately. Consequently, the debugging of the evaluation board is facilitated.

In another aspect of the present invention, the instruction sequence may be created in a machine language that is dependent on the processor configuring the processing module.

The procedure to be executed by the processing module of the evaluation board at the time of a breakpoint hit is pre-registered in the database in the corresponding machine language. The procedure at the time of a breakpoint-hit can be executed at a high rate. Thereby, the status of the evaluation board at the time of a breakpoint-hit can be known even more accurately. Consequently, the debugging of the evaluation board is facilitated.

In accordance with still another aspect of the present invention, the module for pre-setting a breakpoint may include a module for receiving information specifying the breakpoint from a user at the development terminal; and a module for replacing an instruction of a debug-target program on the evaluation board, the instruction corresponding to the information specifying the breakpoint, with a branching instruction that branches control to a handler provided to handle a breakpoint-hit.

The handler is provided to handle a breakpoint hit, and the handler is controlled through a branching instruction to branch control of the procedure to the handler when the breakpoint is hit. Therefore, the procedure at the time of a breakpoint hit can be simplified and executed at a high rate. Thereby, the status of the evaluation board at the time of a breakpoint-hit can be known even more accurately. Consequently, the debugging of the evaluation board is facilitated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an example configuration of a multiprocessor system;

FIG. 2 is a block diagram showing an example configuration of a coprocessor;

FIG. 3 shows a memory map of the coprocessor as viewed from a master processor;

FIG. 4 shows the overall configuration of a remote debugger system according to a first embodiment of the present invention;

FIG. 5 is a table listing the names and functions of the commands used in the remote debugger system of the first embodiment;

FIG. 6 is a block diagram of a front-end section of the remote debugger system according to the first embodiment;

FIGS. 7 and 8 are block diagrams each showing a target board including a resident monitor section of a remote debugger system according to the first embodiment;

FIG. 9 is a flowchart showing a control structure of a procedure executed at a breakpoint-setting time in the front-end section of the remote debugger system according to the first embodiment;

FIG. 10 is a flowchart showing a control structure of a procedure executed at a breakpoint-setting time in the resident monitor section of the remote debugger system according to the first embodiment;

FIG. 11 is a flowchart showing a control structure of a procedure executed at a debugging time in the front-end section of the remote debugger system according to the first embodiment;

FIG. 12 is a flowchart showing a control structure of a procedure executed at a debugging time in the resident monitor section of the remote debugger system according to the first embodiment;

FIG. 13 shows a display example at a debugging time in the remote debugger system according to the first embodiment;

FIG. 14 shows another display example at a debugging time in the remote debugger system according to the first embodiment;

FIG. 15 shows the overall configuration of a remote debugger system according to a second embodiment of the present invention;

FIG. 16 is a block diagram of a front-end section of the remote debugger system according to the second embodiment;

FIGS. 17 and 18 are block diagrams each showing a target board including a resident monitor section of a remote debugger system according to the second embodiment;

FIG. 19 is a flowchart showing a control structure of a procedure executed at a breakpoint-setting time in the front-end section of the remote debugger system according to the second embodiment;

FIG. 20 is a flowchart showing a control structure of a procedure executed at a breakpoint-setting time in the resident monitor section of the remote debugger system according to the second embodiment;

FIG. 21 is a flowchart showing a control structure of a procedure executed at a debugging time in the front-end section of the remote debugger system according to the second embodiment;

FIG. 22 is a flowchart showing a control structure of a procedure executed at a debugging time in the resident monitor section of the remote debugger system according to the second embodiment;

FIG. 23 shows the overall configuration of a remote debugger system according to a third embodiment of the present invention;

FIG. 24 is a block diagram of a front-end section of the remote debugger system according to the third embodiment;

FIG. 25 is a block diagram of a target board including a resident monitor section of a remote debugger system according to the third embodiment;

FIG. 26 shows a configuration of a breakpoint attribute database (DB) in the remote debugger system of the third embodiment;

FIG. 27 is a block diagram of a target board including a resident monitor section of the remote debugger system according to the third embodiment;

FIG. 28 is a flowchart showing a control structure of a procedure executed at a breakpoint-setting time in the front-end section of the remote debugger system according to the third embodiment;

FIG. 29 is a flowchart showing a control structure of a procedure executed at a breakpoint-setting time in the resident monitor section of the remote debugger system according to the third embodiment;

FIG. 30 is a flowchart showing a control structure of a procedure executed at a debugging time in the front-end section of the remote debugger system according to the third embodiment; and

FIG. 31 is a flowchart showing a control structure of a procedure executed at a debugging time in the resident monitor section of the remote debugger system according to the third embodiment.

### DESCRIPTION OF THE PREFERRED EMBODIMENTS

First Embodiment

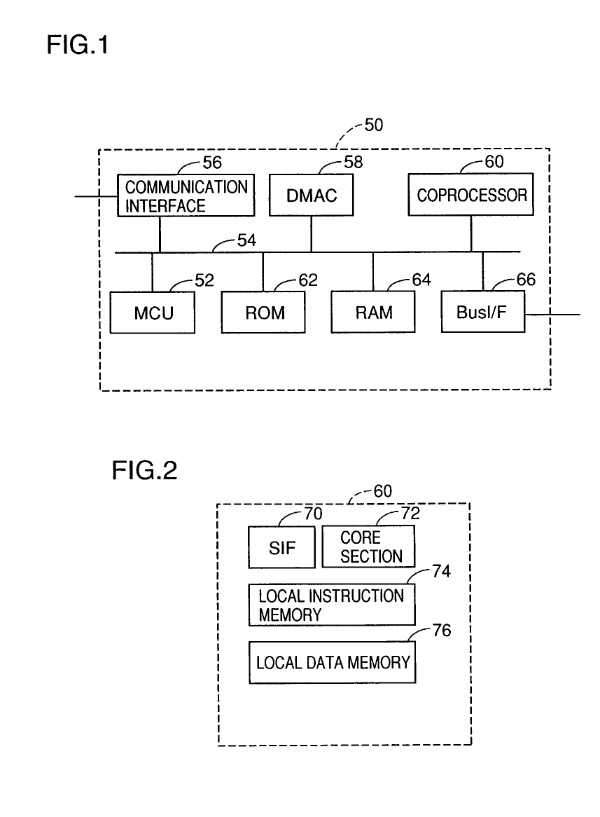

FIG. 1 is a functional block diagram showing an example configuration of a multiprocessor system 50 as a target for remote debugging system according to a first embodiment of the present invention. Referring to FIG. 1, multiprocessor system 50 includes: a processor (MCU) 52 for executing a program to be debugged; a bus 54 to which MCU 52 is connected; a communication interface 56 connected to bus 54 for communicating with a remote debugger running on another engineering workstations or the like; ROM 62 and RAM 64 each connected to bus 54; a DMAC 58 connected to bus 54; a coprocessor 60 connected to bus 54; and a bus interface 66 connected to bus 54 for controlling input/output to/from circuits external to the board.

MCU 52 includes functions for implementing regular breakpoints. Specifically, MCU 52 includes (1) a software-interrupt generation instruction, (2) a return instruction from a software-interrupt, and (3) an operational mode allowing one-instruction execution (single step mode).

Referring to FIG. 2, coprocessor 60 includes: a serial interface (SIF) section 70 for interfacing coprocessor 60 to bus 54; a local instruction memory 74 for storing instructions; a local data memory 76 for storing data; and a core section 72 that includes an arithmetic and logic unit, a memory access controller, and a program-counter (PC) controller.

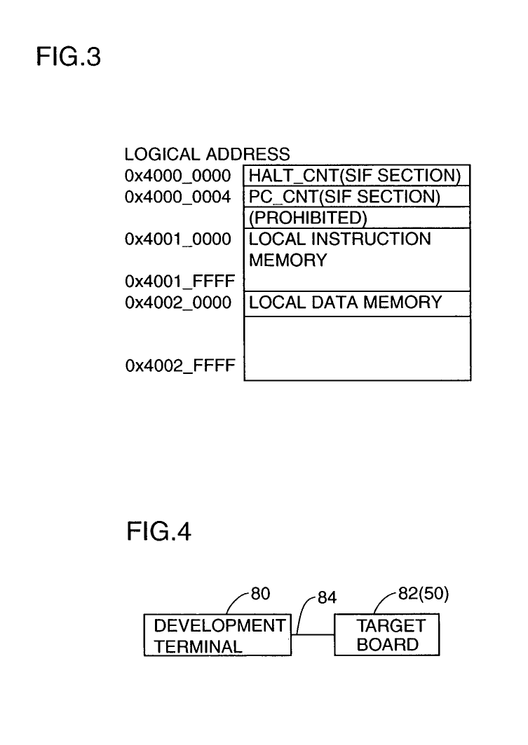

FIG. 3 is a memory map (viewed from the portion of MCU 52) of control registers included in SIF 70, local instruction and data memories 74 and 76. When viewed from MCU 52, coprocessor 60 operates as a memory-mapped device through a general-purpose bus. Referring to FIG. 3, a HALT_CNT register provided in SIF 70 for referencing and controlling the coprocessor is allocated to the head portion of the memory map followed by a PC_CNT register also provided in SIF 70 for setting and reading of a program counter (PC).

MCU 52 references and controls the operation of coprocessor 60 through the HALT_CNT register. Specifically, MCU 52 writes “1” to the HALT_CNT register to activate coprocessor 60 and “0” to the HALT_CNT register to terminate coprocessor 60. When “0” is written to the HALT_CNT register, the operation of coprocessor 60 is stopped. When data in the HALT_CNT register read out by MCU 52 is “1”, coprocessor 60 is active and when the read-out data is “0”, coprocessor 60 is inactive.

By writing a value to the PC_CNT register, a PC count can be set where coprocessor 60 starts execution. Furthermore, when coprocessor 60 is inactive, a PC value to be executed next can be read out of the PC_CNT register.

In multiprocessor system 50 illustrated in FIGS. 1 to 3, after coprocessor 60 is activated, MCU 52 need not await completion of the operation of coprocessor 60 even while MCU 52 operates. Thus, MCU 52 and coprocessor 60 form a master-slave type and loose-coupled type multiprocessor system wherein MCU 52 and coprocessor 60 can operate in parallel (simultaneously).

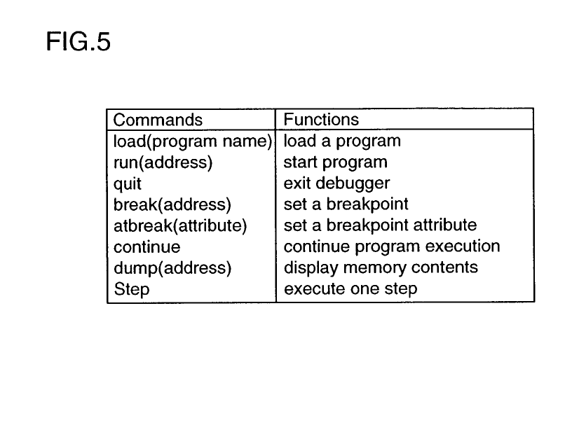

FIG. 4 shows the overall configuration of a debugging system using a multiprocessor system according to the first embodiment of the present invention. Referring to FIG. 4, the debugging system includes a development terminal 80 and a target board 82 coupled to development terminal 80 via a communication path 84. Target board 82 corresponds to multiprocessor system 50 shown in FIG. 1.

In development terminal 80, a front-end section of a debugger operates. The front-end section accepts a command operation of a programmer, and displays the status of software executed on target board 82. On target board 82, a debug-target program is executed, and a resident monitor section of the debugger resides on target board 82. Various types of communication are performed between development terminal 80 and target board 82 through communication path 84 and communication interfaces provided in each unit.

FIG. 5 is a table of commands used in the debugging system according to the present invention. In FIG. 5, commands are shown in the left column, and their respective functions are shown in the right column.

For example, by issuing a “break” command with a specific address, a desired breakpoint can be set at the address. A serial number (identification (ID) number) is assigned to the breakpoint set by the “break” command. By issuing an “atbreak” command with a specific ID number as one of parameters, what should be done when the breakpoint is hit can be specified as a breakpoint attribute.

The syntax of the “atbreak” command is as follows:

atbreak n address (value) (size)

Here, the above parameters are, from the left, a breakpoint number (ID number) “n”, the “address” of the read/write target memory, a “value” to be written at a write, and the read/write memory size “size”. The parameters in parentheses can be omitted. When the parameter “value” is omitted, memory values are at an address specified by the parameter “address” is read out at the breakpoint “n”. When the parameter “value” is specified, the parameter “value” is written to the address specified by the parameter “address”. When the parameter “size” is omitted, the memory read/write size is set to a default size (four bytes).

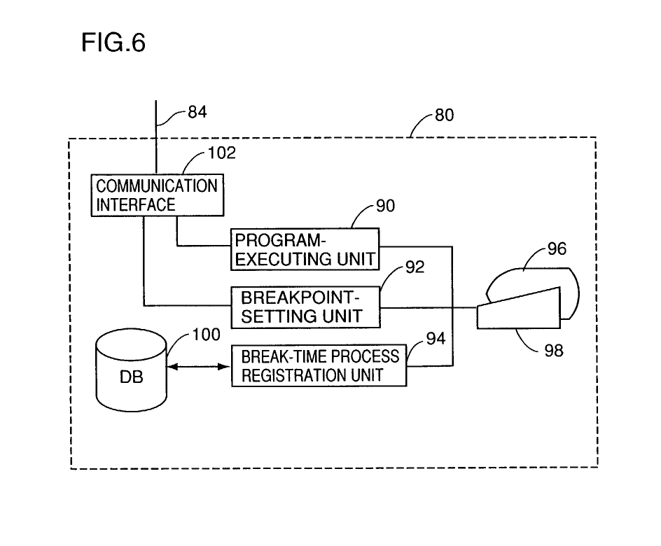

FIG. 6 shows functions in the front-end section of development terminal 80 for implementing the aforementioned “atbreak” command, in the form of a block diagram. Referring to FIG. 6, development terminal 80 includes: a communication interface 102 connected to communication path 84; a monitor 96 and an input unit 98 for providing interactive operations with a programmer and for accepting and outputting commands or data; and a program-executing unit 90 connected to communication I/F 102, monitor 96 and input unit 98 for controlling execution of a program on the target board in response to programmer's commands. Development terminal 80 further includes: a breakpoint-setting unit 92 connected to communication I/F 102, monitor 96 and input unit 98 for setting a breakpoint in a program to be executed on the target board; a breakpoint attribute DB 100 for storing a procedure, for each break point, to be done on the target board when the breakpoint is hit (In this specification, the processing is referred to as an “attribute” of a breakpoint.); and a break-time process registration unit 94 connected to breakpoint-setting unit 98, monitor 96 and input unit 98 for receiving an attribute to a breakpoint from the programmer every time a breakpoint is established and for registering the attribute of the breakpoint in DB 100.

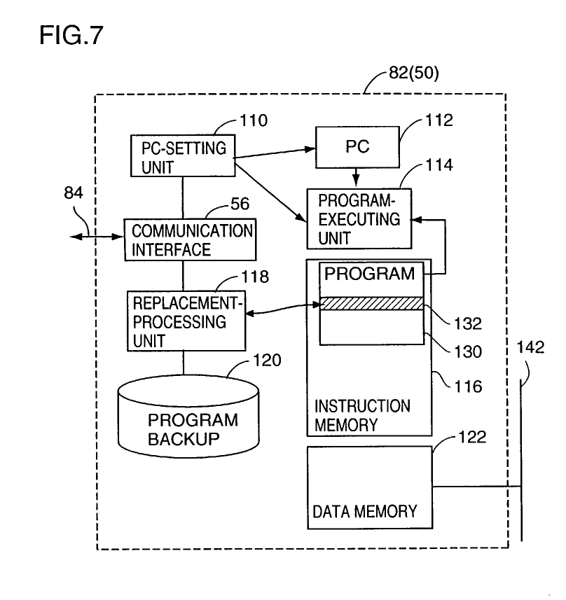

Referring to FIG. 7, target board 82 includes: a program-executing unit 114 with a MCU; a program counter (PC) 112 for specifying an address of an instruction to be executed by program execution unit 114; an instruction memory 116 for storing instructions to be executed by program executing unit 114; and a data memory 122. Command memory 116 and data memory 122 are coupled to a bus 142.

The resident monitor section of the debugger running on target board 82 includes: a communication interface 56 coupled to communication path 84; a PC-setting unit 110 for setting a value of PC 112 in accordance with a programmer's command and for starting the execution of a program in program execution unit 114; and a replacement-processing unit 118 coupled to communication interface 56 for replacing an instruction at an address in program 130 designated by development terminal 80 as a breakpoint with a specific breakpoint instruction 132 and for creating a program backup before the replacement.

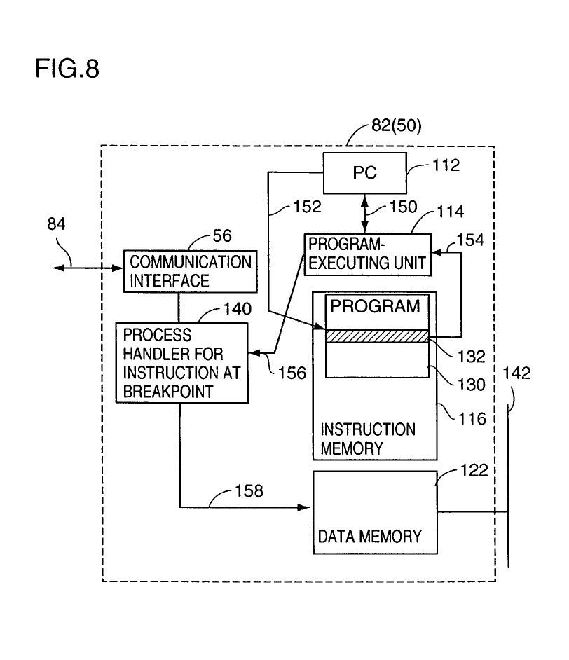

Referring to FIG. 8, resident monitor section further includes a process handler 140 coupled to communication interface 56, being activated by a breakpoint instruction 132 executed by program execution unit 114, for performing a procedure of debugging, including data write/read access to a location in data memory 122 that corresponds to the HALT_CNT register.

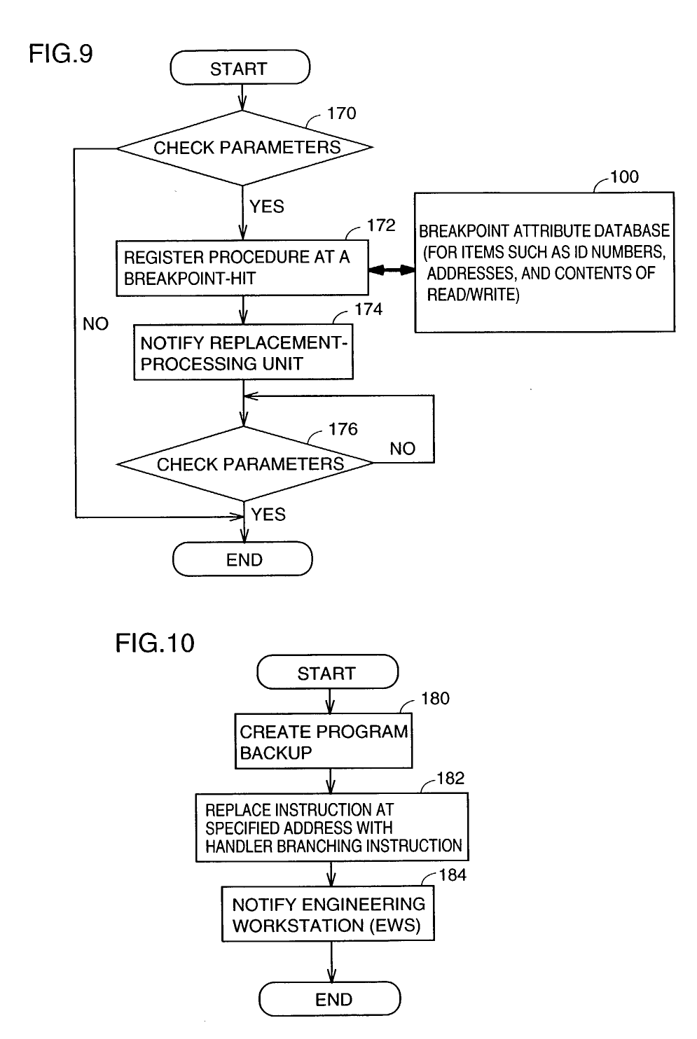

FIG. 9 shows a procedure executed when a breakpoint is set in the front-end section of the debugger in development terminal 80. Referring to FIG. 9, first, at step 170, parameters entered are verified for, for example, the validity of an entered breakpoint ID number and the memory-address alignment. At step 170, if the parameters are determined to be invalid, the procedure terminates. If the parameters are determined to be valid in step 170, control is then passed to step 172.

At step 172, the specified breakpoint ID number and breakpoint-hit-time memory-readout/write procedure associated with the breakpoint are registered in breakpoint attribute DB 100 allocated in an internal storage of development terminal 80.

Subsequently, at step 174, the breakpoint ID number and the address of a breakpoint instruction are notified to replacement-processing unit 118 in the resident monitor section. The front-end section waits for a response from replacement-processing unit 118 in the resident monitor section (step 176) and terminates its procedure upon the response from the resident monitor section.

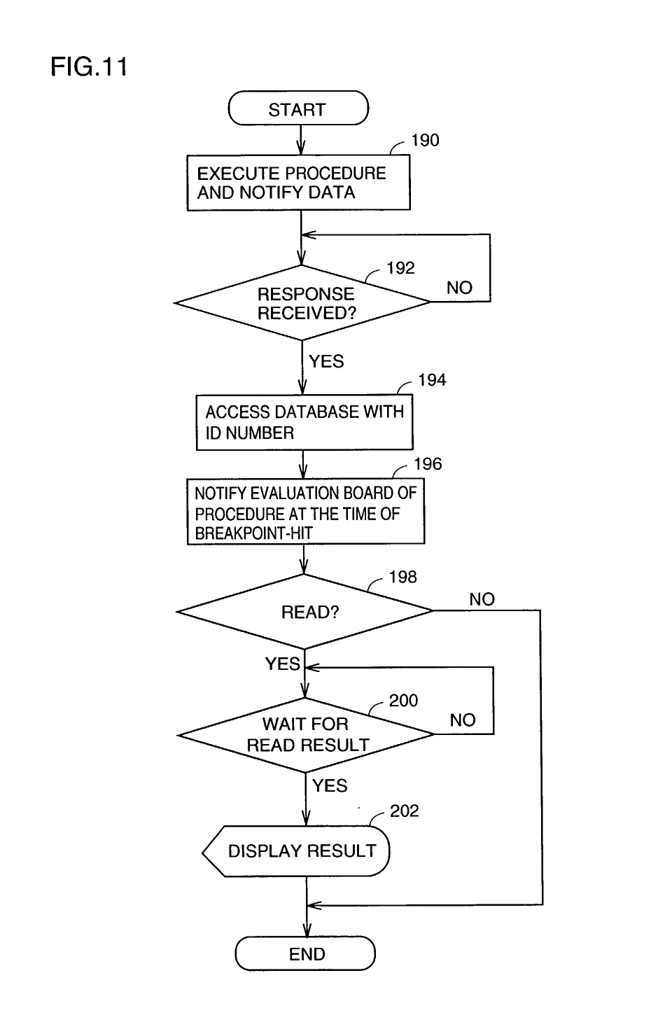

Referring to FIG. 10, the procedure done in the resident monitor section is as follows. First, at step 180, a backup is created for the program specified to be a debug target. Subsequently, at step 182, the instruction at the specified address is replaced with a breakpoint instruction. In practice, the breakpoint instruction generates a software interrupt that transfers control to a handler corresponding to the instruction at the breakpoint. Then, at step 184, the resident monitor section notifies completion of the procedure to development terminal 80, and terminates the procedure.

The above-described procedure completes the preparation for the intended debugging.

In practice, the following procedure is executed at the time of debugging. Referring to FIG. 11, in the front-end section of development terminal 80, first, at step 190, in response to a command entered by a programmer, a start address of a debug-target program is specified, and the execution commencement of the debug-target program is notified to the resident monitor section. Then, the front-end section waits for a response from the resident monitor section (step 192). PC-setting unit 110 in the resident monitor section sets the specified start address into PC 112 and dispatches execution of the program to be commenced to program-executing unit 114. When the program executed by program-executing unit 114 reaches the breakpoint (shown by reference numeral 152 in FIG. 8), a software-interrupt generating instruction 132 in place of the original instruction is executed (reference numeral 154 in FIG. 8) and control transfers to process handler 140 (reference numeral 156 in FIG. 8). The transfer of the control and the ID number of the hit breakpoint are notified to the front-end section.

Upon receipt of the response from the resident monitor section that the breakpoint is reached, the front-end section accesses breakpoint attribute DB 100 with the returned ID number as a key and retrieves the information of the breakpoint-hit-time procedure. The retrieved information is notified to the resident monitor section (step 196). In response to the information, resident monitor section performs a procedure corresponding to the notified procedure, and if the notified procedure is a memory-read, the contents read out of the memory are forwarded to the front-end section.

At step 198, the front-end section determines whether the breakpoint-hit-time procedure is a memory-read. If not, the front-end section terminates the procedure. If the procedure is determined to be a memory-read, the front-end section waits for a memory-read-result notification from the resident monitor section (step 200). Upon receipt of the notification, the front-end section controls monitor 96 to display the contents of the memory (at step 202). Then, the procedure terminates.

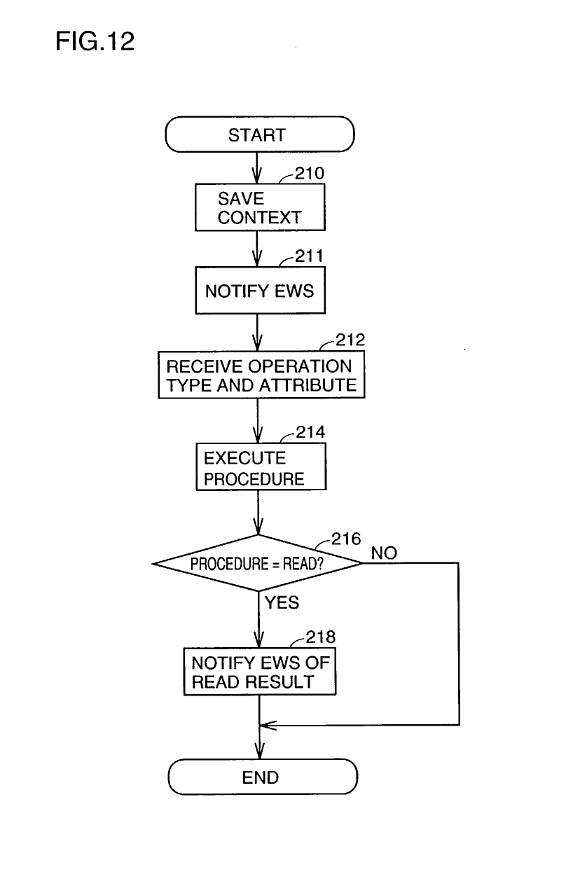

When the breakpoint is hit, the resident monitor section executes a procedure shown in FIG. 12. The procedure commences with an automatic control branch to process handler 140 in conjunction with the execution of software-interrupt generating instruction 132 (reference numerals 152, 154, and 156 in FIG. 8 in this order), which is replaced with the original instruction when the breakpoint is set. A function for implementing step 210 is at the head of process handler 140. That is, the function is built-in as a part of the resident monitor section. At step 210, the context (register contents) of the debug target software is saved in part of data memory 122 allocated to the resident monitor section. Subsequently, at step 211, the resident monitor section notifies the front-end section of the breakpoint-hit instance and an ID number of the hit breakpoint. According to this notification, control transfers to the front-end section (step 194 in FIG. 11). At step 212, in response to the notification, the front-end section notifies the resident monitor section of the type of the breakpoint-hit-time procedure and the attribute. At step 214, upon receipt of necessary information, the resident monitor section performs a procedure of a type determined according to the information. Specifically, when the breakpoint-hit-time procedure is a read out for reading out data from the memory at a predetermined address, the memory contents are read out. Alternatively, when the breakpoint-hit-time procedure is a memory write for writing data to the memory at a prescribed address, the data transferred from the front-end section is written into the memory at the address (reference numeral 158 in FIG. 8).

Subsequently, at step 216, the resident monitor section determines whether the executed procedure is a memory-read. If not, the resident monitor section terminates the procedure. If it is a memory-read, at step 218, the resident monitor section notifies the front-end section of the read result. Then, procedure terminates.

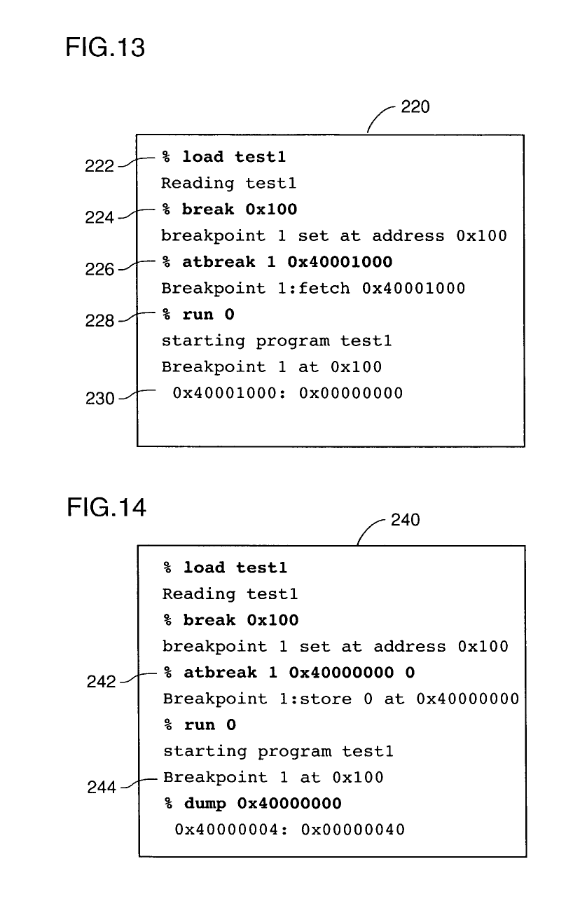

So far, the overall debug operation performed in the system according to the first embodiment is described. FIG. 13 shows an output example 220 of operation of the debugger according to the present embodiment. In FIG. 13, the boldface represents items entered by the user (programmer), and others present items output by the debugger. As shown in the figure, a debug target program is loaded in response to a “load” command 222. Then, a breakpoint is set in response to a “break” command 224 subsequently entered. In example 220 shown in FIG. 13, from the debugger output item subsequent to the “break” command 224, the identification number of the breakpoint can be known to be “1”. Moreover, with an “atbreak” command 226 entered, an attribute is set for the breakpoint. In this particular case, a readout operation for the address “0×40001000” at the breakpoint “1” is set for the attribute. Since no value is specified after the address parameter, the hit-time operation can be known to be “readout”.

Subsequently, a “run” command 228 specifies that the program is executed from the address “0”. As a result, the program is executed in the resident monitor section. Then, when the breakpoint of the identification number “1” is hit, the monitor displays the contents of the memory address specified by the “atbreak” command 226 (reference numeral 230).

FIG. 14 shows another example 240 representing operation and output of the debugger according to the present embodiment. In the example 240, the PC value in the coprocessor at the time the MCU of the target board hits a breakpoint is examined. For a program loaded in response to a “load” command, the breakpoint is set to a predetermined address. In the example 240, the breakpoint is set at address “100”, and the identification number is set to “1”.

Subsequently, an “atbreak” command 242 sets an attribute of the breakpoint (reference numeral 242). In the particular example, at the breakpoint of the identification number “1”, the command 242 specifies the operation of writing “0” into the HALT_CNT register that is mapped to the address “0×400000000”. Specifically, the command has specified termination of the coprocessor when the breakpoint is hit.

Subsequently, the program is executed in response to a “run” command, and the monitor displays a message 244 that the breakpoint 1 is hit. In this particular case, the programmer examines the value of the PC_CNT register mapped to the address “0×40000004”.

In the present embodiment, simplified items have been used with reference to, for example, the target-board configuration, coprocessor specifications, debugger commands for the simplicity purposes. However, as a matter of course, the remote debugger employing the idea of the present embodiment may be implemented with a more complicated configuration. For example, the embodiment is not limited by an example where the programmer enters the debugger commands on the command lines, and the command entry may be instead implemented by using, for example, a GUI (graphical user interface). In addition, the configuration in the coprocessor and the internal resources that can be referenced from the side of the MCU are not limited to the examples shown in the present embodiment.

The system of the first embodiment advantageously dispenses with hardware dedicated to debugging on MCU to implement the debugging of a system including an MCU and slave-type loosely coupled processor (which may be a DMCA). In addition, because of the above-described functions for debugging, termination of a coprocessor, examination of the status of a coprocessor or the like can be easily implemented without a debugger dedicated to the coprocessor. That is, a debugging environment can be established that is parasitic on the debugger for MCU 52. Consequently, the user can perform the overall software debugging only by operating the single debugger and therefore, this facilitates the debugging of a software configuration in which programs in an MCU and a coprocessor operate in cooperation.

(Second Embodiment)

In the debugging environment according to the first embodiment, development terminal 80 is notified that the control has reached a breakpoint. In response, development terminal 80 retrieves the procedure contents, and sends the retrieval result to the resident monitor section. Then, the resident monitor section performs a procedure corresponding to the contents sent from the development terminal. However, the control more or less involves a delay between the time when control reached the breakpoint and the time the actual memory-readout/write procedure is done. Because the coprocessor (or DMAC processor) continues operation in that time delay; therefore, the shorter the delay, the easier it is to obtain accurate information at the breakpoint-hit time. A debugger of a second embodiment is configured to be capable of reducing the delay.

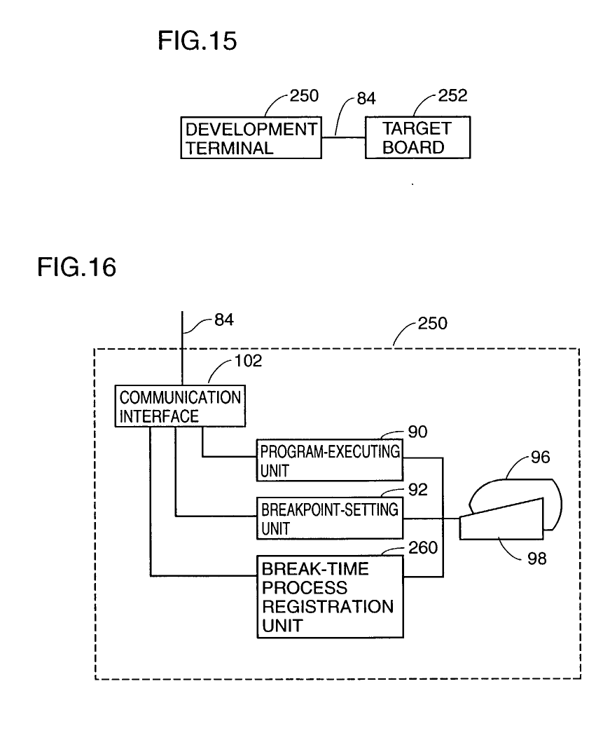

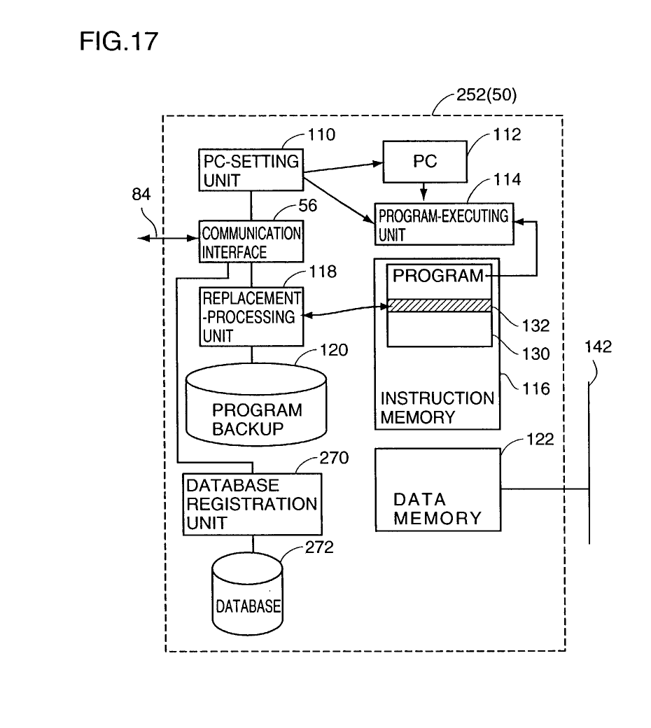

Referring to FIG. 15, similarly to the first embodiment, the debugger system of the second embodiment includes a development terminal 250 and a target board 252 coupled to development terminal 250 via communication path 84. As described above, in the debugger system of the first embodiment, breakpoint attribute DB 100 is included in the front-end section of development terminal 250. However, in the second embodiment, a breakpoint attribute DB 272 (shown in FIG. 17) corresponding to DB 100 is allocated in a resident monitor section of target board 252. This enables the debugger of the second embodiment to reduce the aforementioned delay.

Referring to FIG. 16, the front-end section of development terminal 250 according to the second embodiment is different from the front-end section of the first embodiment shown in FIG. 6 in that: the front-end section of development terminal 250 does not include a database corresponding to breakpoint attribute DB 100 of the first embodiment shown in FIG. 6; and that the front-end section of the second embodiment includes, instead of unit 94 that registers the breakpoint-hit-time procedure to DB 100, a break-time process registration unit 260 coupled to monitor 96 and input unit 98 for notifying the resident monitor section what procedure should be done (entered by a programmer through monitor 96 and input unit 98) when control hits a breakpoint, thereby causing the procedure to be registered in breakpoint attribute DB provided in the resident monitor section. Other functional blocks of the front-end section are the same as those of the front-end section shown in FIG. 6. In FIG. 16, therefore, the same names and reference numerals denote the same component members as shown in FIG. 6. Hence, the detailed descriptions thereof will not repeated here.

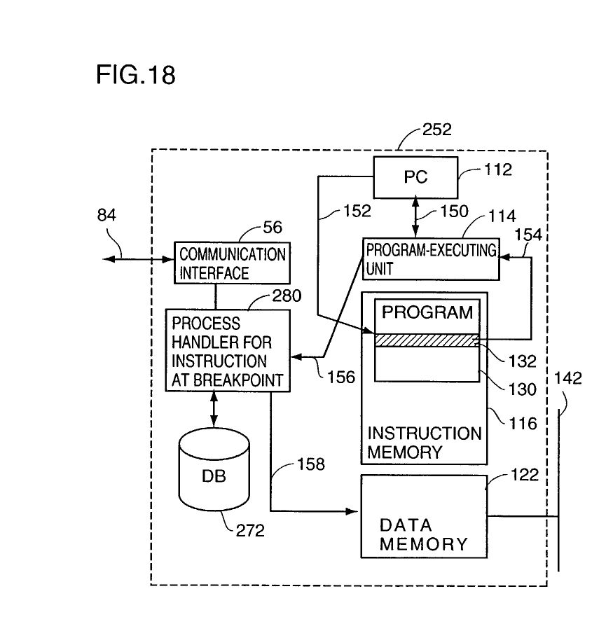

Referring to FIGS. 17 and 18, the resident monitor section of target board 252 according to the second embodiment is different from the resident monitor section according to the first embodiment shown in FIGS. 7 and 8, as follows. Referring to FIG. 17, in addition to the process blocks of configuration members shown in FIG. 7, the resident monitor section includes a database registration unit 270 that receives the contents of the breakpoint-hit-time procedure from break-time process registration unit 260 of the front-end section and registers the aforementioned data in breakpoint attribute DB 272 allocated to an internal storage.

In addition, referring to FIG. 18, instead of handler 140 shown in FIG. 8, the resident monitor section includes a handler 280 as a functional block used in debugging. Different from process handler 140, handler 280 does not handle the notification of breakpoint-hit-time data to the front-end section via the communication interface. Handler 280 references breakpoint attribute DB 272 provided in the resident monitor section, determines the type of procedure required at the breakpoint-hit time, and performs the determined procedure.

In FIGS. 17 and 18 and FIGS. 7 and 8, the same blocks are labeled with the same reference numerals and names. Hence, the detailed descriptions thereof will not be repeated here.

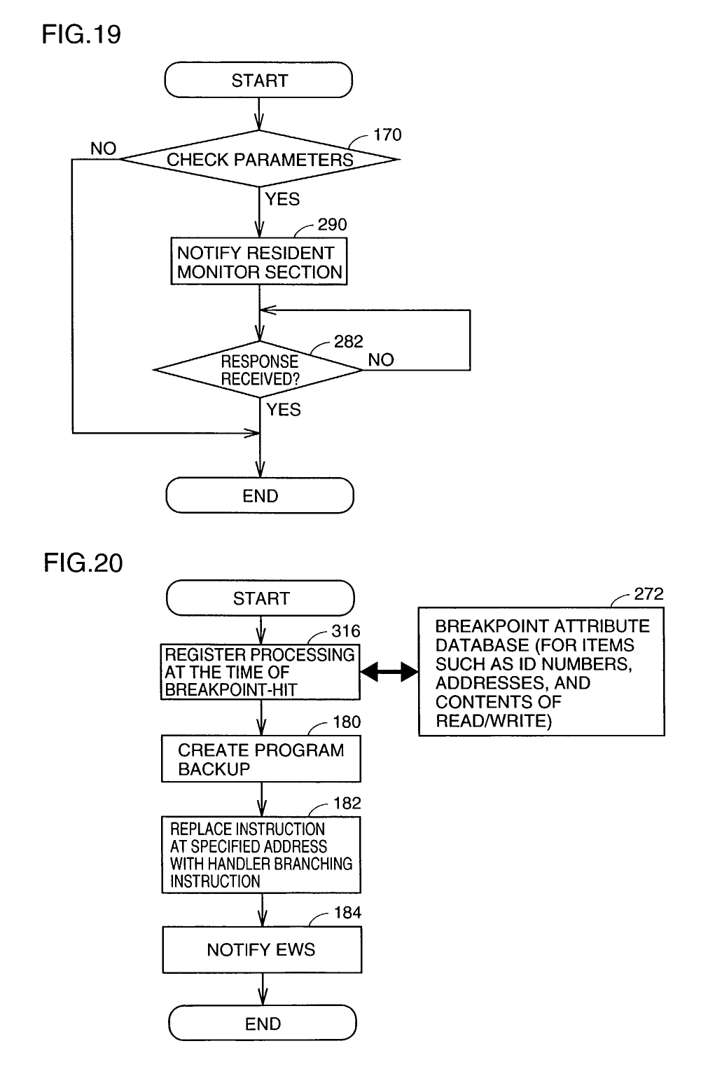

FIG. 19 is a flowchart of procedure executed when a breakpoint is set in the front-end section of the debugger system according to the second embodiment. Referring to FIG. 19, the entered parameters are checked. For example, the validity of an entered breakpoint ID number and the memory-address alignment (step 170) and the like are checked. If the parameters are not valid, procedure terminates. If the parameters are valid, control proceeds to step 290.

At step 290, replacement-processing unit 118 and database registration unit 270 are notified of the ID number of a specified breakpoint, the instruction address at the breakpoint, and the contents of breakpoint-hit-time memory-readout/write procedure associated with the breakpoint.

Subsequently, at step 292, the front-end section waits for a response from the resident monitor section. When a response is received from the resident monitor section, the procedure terminates.

FIG. 20 is a flowchart of the procedure performed in the resident monitor section in response to the notification received from the front-end section at step 290. Referring to FIG. 20, first, at step 316, a procedure is performed to register the notified contents of the breakpoint-hit-time procedure into breakpoint attribute DB 272. The procedure of step 316 corresponds to the registration to database registration unit 270 shown in FIG. 17. Subsequently, at step 180, a backup of program 130 is created. Then, at step 182, the instruction at the notified address is replaced with software-interrupt generating instruction 132 that transfers the control to handler 280. Then, at step 184, the resident monitor section notifies the front-end-section of the completion of the procedure. The procedure of the above-described steps corresponds to the procedure that is executed by the function of replacement-processing unit 118 shown in FIG. 17.

As described above, through the procedure shown in FIGS. 19 and 20, the instruction of program 130 at the breakpoint is replaced with software-interrupt generating instruction 132 that transfers the control to the handler. In addition, the breakpoint-hit-time procedure is registered in breakpoint attribute DB 272.

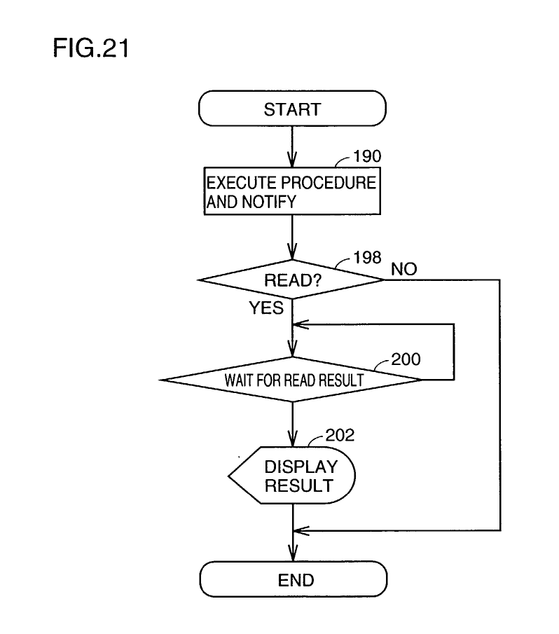

Debug procedure will be described below. Referring to FIG. 21, first, at step 190, in response to the command entered by the programmer, a start address of a debug-target program is specified, and the execution commencement of the program is notified to the resident monitor section. Subsequently, at step 198, the front-end section determines whether the breakpoint-hit-time procedure is a memory-read. If not, the procedure terminates. If it is a memory-read, the front-end section waits for a memory-read-result notification (step 200). Upon receipt of the notification, at step 202, the front-end section controls monitor 96 to display the contents of the memory. Then, procedure terminates.

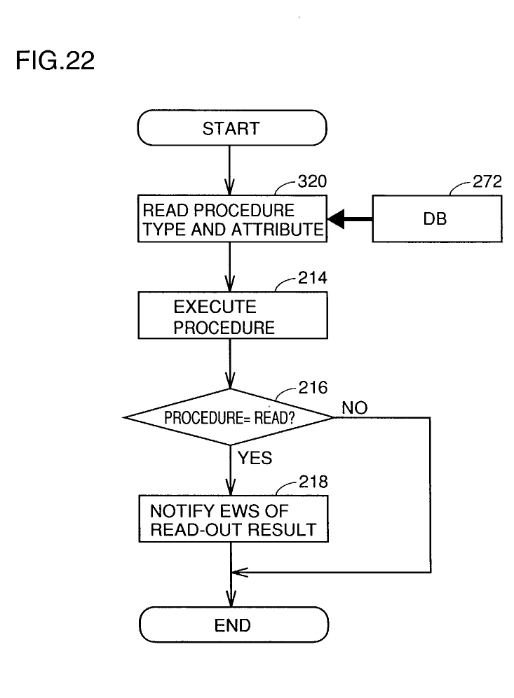

Referring to FIG. 22, a description will be made in the following on the procedure performed by the resident monitor section. Referring to FIG. 22, when a breakpoint is hit, instead of passing control to the front-end section, the resident monitor section of the second embodiment accesses at step 320 the breakpoint attribute DB 272 provided in a memory area allocated on target board 252 for the resident monitor section. The resident monitor section reads out information and at step 214, it performs a procedure determined according to the read-out information. Specifically, if the breakpoint-hit-time procedure is reading data from the memory at a predetermined address, the memory contents are read out. Alternatively, when the breakpoint-hit-time procedure is writing data into the memory at a predetermined address, the data transferred from the front-end section is written into the memory area at the predetermined address (as shown by reference numeral 158 in FIG. 18).

Subsequently, at step 216, the resident monitor section determines whether the executed procedure is a memory-read (step 216). If not, the procedure terminates. If it is a memory-read, at step 218 the resident monitor section notifies the front-end section of the read-out result. Then, the procedure terminates.

As described above, in the second embodiment, after the breakpoint is hit, communication is not performed in the front-end section and the resident monitor section before the execution of the memory-readout/write. However, the information required can instead be obtained on target board 252. Hence, the overhead for communication with the front-end section is reduced, and the delay can be reduced between the breakpoint-hit time and the execution time of the memory-readout/write. Consequently, even more accurate breakpoint-hit-time information can be examined, and even more efficient debugging can be performed for coprocessors and other units.

(Third Embodiment)

In the remote debugger according to the second embodiment, breakpoint attribute DB 272 is used to register procedure items, such as the type of readout/write and target addresses of the readout/write when the breakpoint attributes are to be set. In debugging, breakpoint attribute DB 272 is referenced when a breakpoint is hit before the associated information is retrieved, and actual procedure is determined according to the contents of the retrieved information.

In the debugger of the second embodiment, however, latency is caused since the procedure type is selected according to the result of referencing to breakpoint attribute DB 272. The latency causes a delay in the period from the breakpoint-hit time up to the execution time of the memory-readout/write procedure. Hence, if the delay is reduced, the accuracy of the breakpoint-hit-time information can further be improved; that is, even more accurate breakpoint-hit-time information can be obtained.

To reduce the delay, the remote debugger system of the third embodiment is configured such that the procedure items such as the type of readout/write and the address are not registered in breakpoint attribute DB 272 but that process handlers (subroutines) are created and prestored in RAM 64 that will be directly invoked at the time of debugging. The handlers are each composed of an instruction sequence (created in an MCU-dependent language) that can be executed by MCU provided for implementing the readout/write procedure. Each of the process handlers is formed of a machine-language instruction sequence dedicated to a corresponding breakpoint and therefore, the procedure can be performed at a higher rate, compared to the case where a general-purpose handler is used.

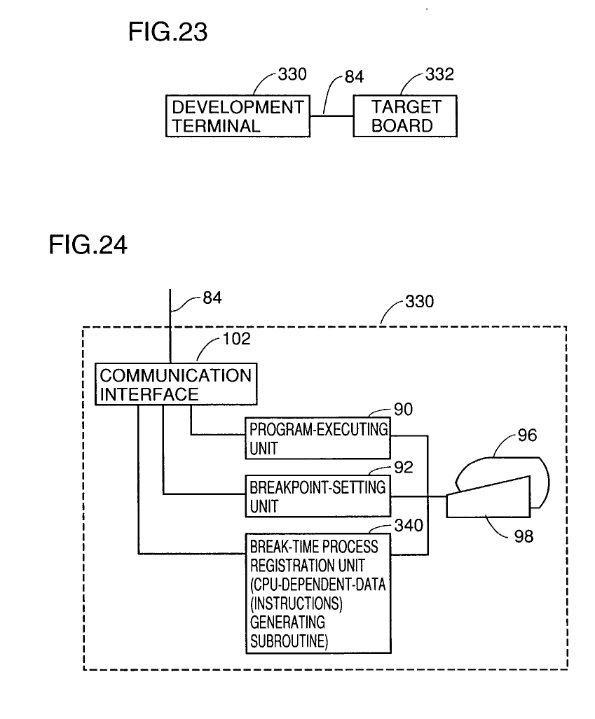

FIG. 23 shows an overall configuration of a remote debugger system according to the third embodiment of the present invention. Referring to FIG. 23, the debugger system of the third embodiment includes a development terminal 330 upon which a front end section operates that has a function of creating the above-described subroutines, and a target board 332 coupled to development terminal 330 via communication path 84 upon which a resident monitor section operates. The resident monitor section has a function for executing a corresponding one of the subroutines when a breakpoint is reached. Development terminal 330 corresponds to multiprocessor system 50 as shown in FIG. 1.

FIG. 24 is a functional block diagram of the front-end section of development terminal 330. The front-end section is different from that of the second embodiment shown in FIG. 16 in that, in place of unit 260 that only transfers breakpoint-hit-time procedure items to the resident monitor section, the front-end section of development terminal 330 includes a break-time process registration unit 340 that has a function to generate data dependent on the processor in the debug-target system (that is, the data represents subroutines each composed of an instruction sequence that can be executed by the processor), and transfers the data (subroutine) to the resident monitor section. This function is executed according to the breakpoint-hit-time procedure items entered through a program.

In FIG. 24, the same components as those in FIG. 16 are labeled with the same names and reference numerals in FIG. 16. Hence, the detailed descriptions thereof will not repeated here.

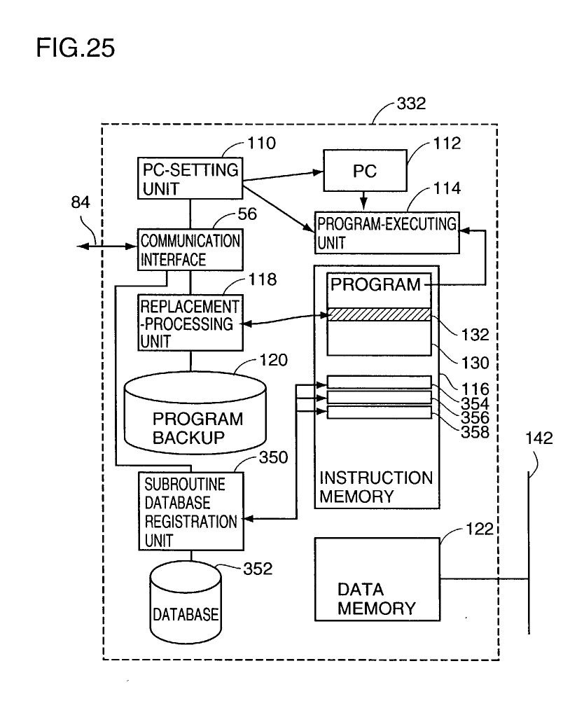

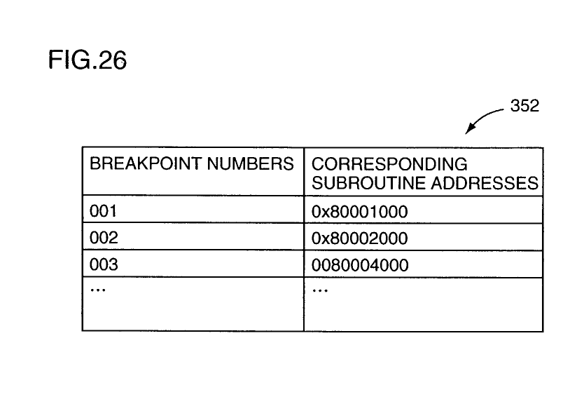

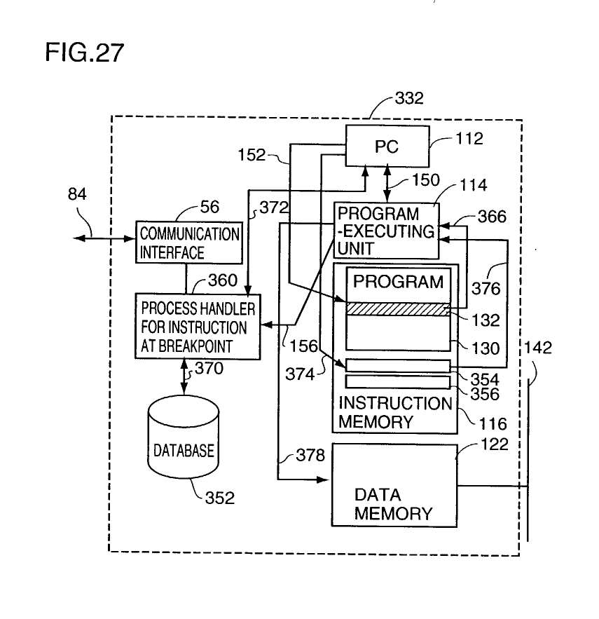

FIGS. 25 and 27 each show a configuration of the resident monitor section that operates on target board 332. As shown in the FIG. 25, the resident monitor section of target board 332 according to the third embodiment is different from that of the second embodiment shown in FIG. 17, as follows. In the configuration shown in FIG. 25, in place of database registration unit 270 that registers data to breakpoint attribute DB 272, the resident monitor section of the third embodiment includes a subroutine database registration unit 350 coupled to communication interface 56 for storing subroutines 354, 356, 358 and so forth in instruction memory 116, that are received from front-end section via communication interface 56, to be executed at a breakpoint hit and for registering data as shown in FIG. 26 into breakpoint attribute DB 352. Specifically, the registration data represents associated data of addresses of memory fields storing individual subroutines and ID numbers of breakpoints corresponding to the individual subroutines.

The resident monitor section shown in FIG. 27 is different from the resident monitor section of the second embodiment shown in FIG. 18, as follows. The resident monitor section shown in FIG. 27 includes a process handler 360 in place of handler 280 that accesses breakpoint attribute DB 272, reads out procedure items, and performs a procedure specified in the procedure items. Process handler 360 accesses breakpoint attribute DB 352 (as shown by reference numeral 370 in FIG. 27) with a key of the ID number of a corresponding breakpoint. Then, process handler 360 reads out the address where a corresponding one of the subroutines is stored, and sets the read-out address into PC 112 (as shown by reference numeral 372). Concurrently, process handler 360 passes control to program-executing unit 114 so that the program is executed from the address set into PC 112.

Program-executing unit 114 executes the subroutine (as shown by reference numeral 376) specified by PC 112 (as shown by reference numeral 374). Thereby, the procedure specified in data memory 122 for debugging is performed.

As shown in FIG. 26, breakpoint attribute DB 352 stores breakpoint numbers (ID numbers). It also stores the addresses of memory fields storing corresponding subroutines generated according to procedure items that should be executed when the breakpoint is hit. The breakpoint numbers and the addresses are stored in association with each other.

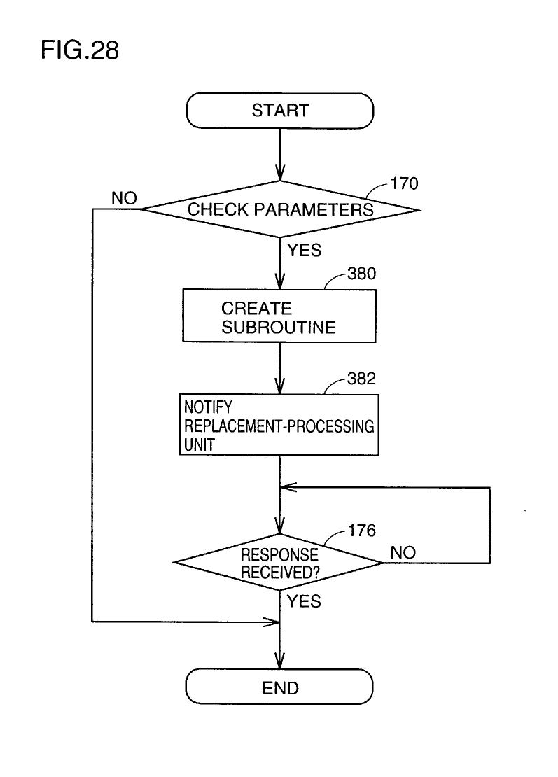

Referring to FIG. 28, front-end section according to the third embodiment operates as follows at a breakpoint-setting time. In the figure, first, entered parameters are checked. For example, the validity of an entered breakpoint ID number and the memory-address alignment (step 170) are checked. If the parameters are not valid, the procedure terminates. If the parameters are valid, control proceeds to step 380.

At step 380, a subroutine for implementing memory-readout/write procedure when the specified breakpoint is hit is created in a machine-language sequence that is dependent on MCU 52 provided on evaluation board 332. Subsequently, at step 382, the ID number of the specified breakpoint and the corresponding subroutine is notified to the resident monitor section. At step 176, the front-end section waits for a response from replacement-processing unit 118 in the resident monitor section. When a response is received from the resident monitor section, the procedure terminates.

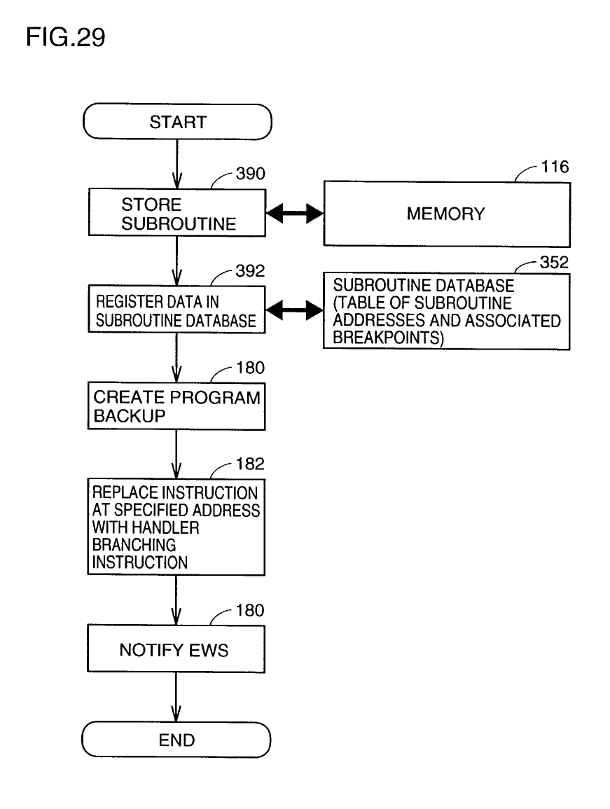

Referring to FIG. 29, a procedure executed at a breakpoint-setting time in the resident monitor has following control structure. The procedure in the resident monitor section commences with receiving the notification issued at step 382 (shown in FIG. 28) from the front-end section.

Then, at step 390, the received subroutine is stored in instruction memory 116. At step 392, the associated storage addresses and breakpoint ID numbers are stored in breakpoint attribute DB 352.

Subsequently, at step 180, a backup is created for program 130 specified as a debug target. Then, at step 182, the instruction at the specified address is replaced with software-interrupt generating instruction 132 that transfers the control to handler 360. At step 184, the resident monitor section notifies the front-end section of the completion of the procedure. Then, the procedure terminates.

The above-described procedure completes the preparation for debugging.

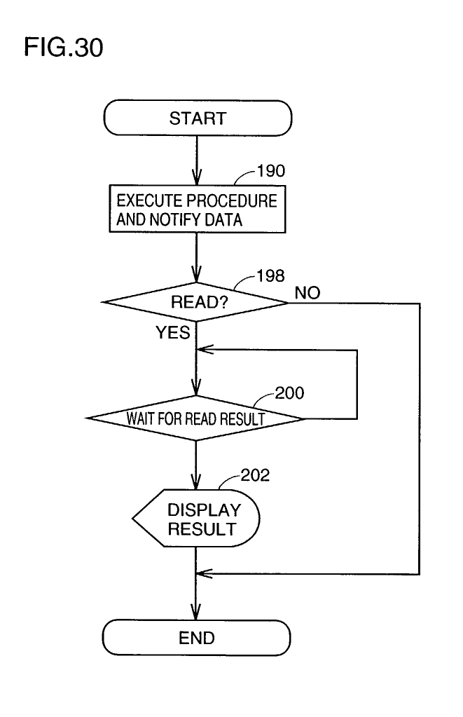

Debug-related procedure executed in the front-end section includes a control structure shown in FIG. 30. Referring to FIG. 30, in the front-end section of development terminal 330, at step 190, in response to a command entered by a user (for example, programmer), the start address of a debug-target program is specified, and the execution commencement is notified to the resident monitor section. Subsequently, at step 198, the front-end section determines whether the breakpoint-hit-time procedure is a memory-read. If the procedure is determined not to be a memory-read, the procedure terminates. Then, at step 200, the front-end section enters a standby state awaiting a memory-readout-result notification. When the notification is received, at step 202 the contents of the notification are displayed. Then, the procedure terminates.

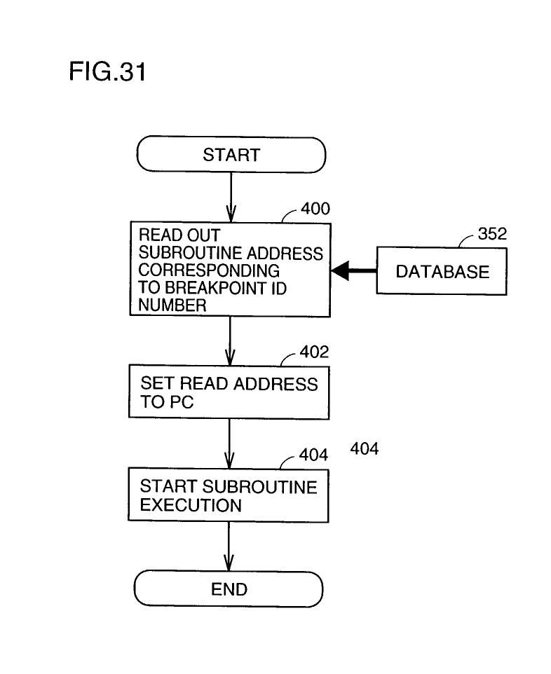

Debug-related procedure executed in the resident monitor section according to the third embodiment includes a control structure shown in FIG. 31. The procedure commences when the specified breakpoint is hit. Then, the front-end section accesses breakpoint attribute DB 352, and reads out the subroutine address corresponding to the ID number of the hit breakpoint. The read-out address is then set into PC 112 (as shown in reference numeral 372 in FIG. 27). Program-executing unit 114 is controlled to commence program execution from the address specified by PC 112. In the procedure, as shown by reference numerals 374 and 376 in FIG. 27, program-executing unit 114 executes, for example, subroutine 354 as a corresponding subroutine. As described above, subroutine 354 is composed of an instruction sequence for performing a read/write of the contents of the specified address in data memory 122. That is, the subroutine execution implements procedure corresponding to the breakpoint, as shown by reference numeral 378.

As described above, the remote debugger of the third embodiment does not use general-purpose functions to perform a memory-read/write, but the remote debugger instead uses the subroutines each composed of the MCU-dependent instruction sequence dedicated for the read/write for the corresponding breakpoint. In this case, the latency is less than that in the case where a general-purpose function is executed with a result of database reference. In addition, the subroutine composed of the dedicated instruction sequence can be executed by using a smaller number of instructions than the general-purpose functions. This reduces the execution time. Hence, compared to the case of the second embodiment, a further reduction can be implemented for the delay in the period from the breakpoint-hit time up to the execution time of the memory-readout/write procedure. Consequently, the third embodiment enables the examination of even more accurate breakpoint-hit-time information. Furthermore, the debug precision can be improved. Still furthermore, the third embodiment further facilitates the debug procedure.

According to the above-described embodiments of the present invention, compared to a case where a user specifies the contents of a procedure when a specific breakpoint is hit, the delay can be reduced in execution of debugging after the breakpoint is hit.

In addition, since the breakpoint attribute database is included in the evaluation board, the breakpoint-hit-time communication overhead is reduced. This reduces the delay in executing of debugging process after the breakpoint-hit time.

Furthermore, since the breakpoint attribute database is included in the development terminal, the debug-dedicated remote resident section on the evaluation board can be minimized. This makes it easy to design the evaluation board.

Furthermore, when a breakpoint is hit, the relevant data can be read out of the evaluation-board memory address pre-registered in the breakpoint attribute database, and the data can be displayed. Thereby, the time required to read out the data after the breakpoint is hit can be reduced. This enables the status of the evaluation board at the time of the breakpoint-hit to be known even more accurately.

Still furthermore, when a breakpoint is hit, data pre-registered in the breakpoint attribute database can be written in a memory at the address pre-registered in the breakpoint attribute database. Thereby, the time required to write the data after the breakpoint is hit can be reduced. This enables the status of the evaluation board at the time of breakpoint-hit to be reflected upon the debugging even more accurately.

Still furthermore, the procedure to be executed when a breakpoint is hit is converted into the processor-dependent instruction sequence. When the breakpoint is hit, the processing module of the evaluation board is controlled to directly execute the instruction sequence. Thereby, high-rate execution can be achieved for the procedure to be performed for the debug procedure when the breakpoint is hit. In addition, the delay will be reduced in executing debugging process after the breakpoint-hit. That is, the time required to read out the data after the breakpoint is hit can be reduced. This enables the status of the evaluation board at the time of breakpoint-hit to be known even more accurately.

In the case where the breakpoint-hit-time procedure to be executed by the processing module of the evaluation board is pre-registered in the database in a corresponding machine language, the breakpoint-hit-time procedure can be executed at a high rate. Thereby, the status of the evaluation board at the time of the breakpoint-hit can be known even more accurately.

Yet further more, a handler is provided to execute a procedure at the time of breakpoint-hit, and the control of execution is transferred to the handler through a branching instruction when a breakpoint is hit. Therefore, the procedure at the time of the breakpoint-hit can be simplified, and can be executed at a high rate. Thereby, the status of the evaluation board at the time of the breakpoint-hit can be known even more accurately.

Although the present invention is described and illustrated in detail, it is clearly understood that the same is by way of illustration and example only and is not to be taken by way of limitation, the spirit and scope of the present invention being limited only by the terms of the appended claims.

What is claimed is:

1. A remote debugging apparatus that uses a development terminal coupled to an evaluation board to perform debugging of a program executed in said evaluation board including a plurality of processing modules including a processor in a master-slave configuration, said remote debugging apparatus comprising:
setting means for pre-setting a breakpoint in said program executed in said evaluation board;
registering means for registering a procedure in a database provided in one of said evaluation board and said development terminal, the procedure being required to be performed for a memory on said evaluation board when said breakpoint is hit;
execution-commencing means for commencing the execution of said program in said evaluation board; and
execution-controlling means of referencing said database in response to a hit on said breakpoint in execution of said program, and controlling the processing module of said evaluation board to execute a procedure required to be done on the memory of said evaluation board.

2. The apparatus according to claim 1, wherein:
said registering means includes means for pre-registering an address in the memory of said evaluation board in said database provided in one of said evaluation board and said development terminal, the address being required to be accessed when said breakpoint is hit; and
said execution-controlling means includes:
means for referencing said database in response to a hit on said breakpoint in execution of said program, reading out data in the memory of said evaluation board at an address read out of said database, and controlling the processing module to notify the read-out data to said development terminal; and
means for outputting to outputting means the data notified to said development terminal.

3. The apparatus according to claim 1, wherein said setting means includes:
means for receiving information specifying said breakpoint from a user in said development terminal; and
means for replacing an instruction of a debug-target program in said evaluation board, the instruction corresponding to the information specifying said breakpoint, with a branching instruction that branches control to a handler provided to handle the breakpoint-hit.

4. The apparatus according to claim 1, wherein:
said registering means includes means for pre-registering in said database an address in the memory of said evaluation board and data required to be written at the address, the address being required to be accessed when said breakpoint is hit, and said database being provided in one of said evaluation board and said development terminal; and
said execution-controlling means includes means for referencing said database in response to a hit on said breakpoint in execution of said program, and controlling the processing module of said evaluation board to write data read out of said database in the memory of said evaluation board at an address read out of said database.

5. The apparatus according to claim 1, wherein:
said registering means includes means for generating an instruction sequence dependent upon the processing module required to be executed by the processor of said evaluation board according to a command from a user at said development terminal when said breakpoint is hit; and
said execution-controlling means includes means for referencing said database in response to a hit on said breakpoint in execution of said program, and providing the processing module with said instruction sequence read out of said database to be executed.

6. The apparatus according to claim 5, wherein said instruction sequence is created in a machine language that is dependent on the processor configuring said processing module.
